(19) United States
(12) Patent Application Publication
(10) Pub. No.: US 2006/0197961 A1
(43) Pub. Date: Sep. 7, 2006

(54) Portable photographic printing method and apparatus

(76) Inventors: David L. Kidd, Kansas City, KS (US); Lester N. Beason JR., Kansas City, MO (US); Donte L. Ross, Lenexa, KS (US)

Correspondence Address: Arthur Shaffer;Intellectual Property Center, LLC, 14072 W. 115th Street, Olathe, KS, 66062, US

(21) Appl. No.: 11/070,538

(22) Filed: Mar. 2, 2005

(51) Int. Cl. G06F 3/12

(52) U.S. Cl. 358/1.1; 358/527

(57) ABSTRACT

A portable printing apparatus for printing photographs using a portable printing device and a portable electronic device wherein the portable printing apparatus includes a first and second opening, the first opening being adapted to receive the portable printing device such that the photograph, once printed, is discharged from the second opening, the apparatus further including a support strap to position the apparatus and the portable printing device in a generally horizontal orientation for printing the photographs.

### FIELD OF THE INVENTION

The present invention relates to a method and apparatus for portably printing photographs and, more particularly, to a method and apparatus for transporting photographic equipment to social events and dispensing the photographs through the portable apparatus.

### BACKGROUND OF THE INVENTION

A person may wish to memorialize an event through the use of visual indicia such as photographs or other visual recordings. These visual recordings may be displayed using a number of different technologies, including printed photographs or other image display devices such as electronically displaying the image on a computer screen or another digital image viewer. However, these display methods have some disadvantages.

Traditional photographs have been around a number of years. However, traditional photographs have disadvantages including some photographs must be photo chemically processed using specialized equipment and toxic chemicals in dark rooms. The specialized equipment can be very expensive and complicated for the average non-professional photographer. Also, the toxic chemicals can create environmental issues. Alternatively, the leisurely photographer can have the undeveloped images developed by a photographic development center. However, because the entire roll of film must be re-wound and submitted for development and because a roll of film may not be used-up at any one time or event, it may be weeks, months or even years before the recorded media is deposited. In addition, because a photographic development center is only open certain hours and the development process takes time; once the film is deposited it may be an additional time after the film is ready for processing before the photographs are available. It would be beneficial to have a portable photographic device which could provide photographs at a time near the event being visually recorded. In addition, it would be beneficial to have a photograph of an event, without subjecting the inexperienced photographer to expensive equipment costs or environmental issues.

A known method of photography utilizes a portable photographic printing apparatus, such as portable cameras with self developing film, which allows for the recording of a visual image along with the creation of a physical picture. Although these photographic apparatuses provide photographs, they require the use of specialized equipment such as specific cameras and specific film for the printed photographs. This specialized equipment, however, may not utilize the benefits which are available with digital cameras and digital photography. In addition to the specialized cameras and film, this known photographic process involves the use of potentially harmful chemicals to develop these photographs. Also, the specific film has an expiration date at which time the film should be consumed. It would be beneficial to have a portable printing apparatus which utilized standard digital photographic equipment.

Digital image processing devices are a relatively recent phenomenon and have become increasingly popular. Many digital cameras include features to assist in allowing a relatively inexperienced photographer take relatively good pictures. In addition, the advances in storage media have allowed for a digital camera to take several pictures using a single storage device. However, even with the advances in digital photography, there are some disadvantages to the current use of digital photography. Even though electronic images can be displayed on an electronic device, some consumers avoid developing the images into traditional photographs. Also, electronic displays of a visual recording may appear attractive on a computer screen; however, they are not visible when the digital device is turned off. In addition, although an electronic image may be relatively easy to transfer to different users, the electronic image looks different based upon the users' electronic device settings. Some electronic image files may also become lost, forgotten or corrupt after a period of time. It would therefore be beneficial to have an apparatus which combined the developments of modern digital photography with “traditional” photographs allowing for printed photographs of an event to be provided at or near the time of the event, the photographs being captured using a portable digital camera.

Technological advances allow for the digital recording and processing of multimedia information such as pictures using computer processing designs. However, even with the advances in technology the use of portable electronic equipment such as photographic printing apparatuses have been generally limited to non portable conditions. One reason for this delay may be the need to protect the devices from damage. Another concern may be the need to carry along additional accessories to fully utilize such portable electronic devices. One way to carry portable printing apparatuses with additional accessories is within a briefcase or other portable hand carrier which may require the use of a hand to carry. Some of these containers may be bulky and heavy, limiting the use of these devices. In addition because this carrying method often requires the use of the hands to carry the container, this carrying method limits the use of the hands to operate the printing apparatus during transportation. It would be beneficial to have a portable hands-free portable printing apparatus which allowed for the transportation of portable printing devices with printing accessories.

Another concern with regard to modern digital photography is the ability to develop photographs from a digital camera. While digital photographs are visible using an electronic display screen, the ability to process the images often requires the user to provide a digital memory storage device with the digital images stored thereon to develop the pictures. This means that unless the user has redundant storage devices, the user can not use the digital camera until the storage device is replaced. In addition, because of the increased cost of a storage device over a roll of film, the user has more at risk unless and until the storage device returned. If the user is self-developing the digital images, the user may need to be computer literate, able to afford expensive graphical image editing software. In addition, converting the electronic image into a more permanent picture may require travel from the photographed location to a person's home, work or a photo developing establishment to convert the electronic information into a physical picture printed on some form of tangible media, such as paper. It would be an advantage to have a portable printing apparatus which provided a printed photograph after taking a picture without travel away from the photographed location, without requiring any computer expertise or expensive image editing software.

### SUMMARY OF THE INVENTION

The present invention provides a method and apparatus for portably printing a photograph using a digital device connected to a portable printer. Specifically, the present invention relates to a flexible structure having a support strap with an interior area surrounding a portable printing device, the flexible structure containing two openings for receiving the portable printing device and dispensing photographs. The support strap helps to assist the user in transporting and holding the printing device in a horizontally upright position.

### BRIEF DESCRIPTION OF THE DRAWINGS

FIG. 1 is a top plan view of the portable printing apparatus with a first opening partially closed.

FIG. 2 is a side elevational view of the flexible apparatus.

FIG. 3 is a side elevational view of the flexible apparatus.

FIG. 4 is a longitudinal side elevational view of the flexible apparatus with the second opening.

FIG. 5 is a bottom plan view of the portable printing apparatus.

FIG. 6 is a side perspective view of the portable printing device received within the interior compartment of the portable printing apparatus.

FIG. 7 is a top perspective view of the portable printing apparatus being transported by a hand strap.

FIG. 8 is a top perspective view of the portable printing apparatus being supported by a support strap.

FIG. 9 is a side perspective view of the portable printing apparatus in receipt of the portable printing device being supported by the support strap as print media is received by and through the portable printing device.

FIG. 10 is a rear perspective view of an alternative support strap arrangement.

### DETAILED DESCRIPTION

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Said terminology will include the words specifically mentioned, derivatives thereof and words of similar meaning.

### II. Preferred Embodiment Portable Printing Apparatus 20

Referring to the drawings in more detail, the reference numeral 20 refers to a portable printing apparatus. The portable printing apparatus 20 is designed to operate with a portable printing device 12 to portably print photographs 14, not shown. The portable printing apparatus 20 includes a flexible wall structure 22 having an interior compartment 24 sized for accommodating the portable printing device 12. Generally, the flexible wall structure 22 includes a top, a bottom and at least one side panel, the top being generally separated from the bottom by a side panel in accordance with the present invention. The portable printing apparatus 20, in general provides a printing support surface with a horizontal configuration for printing photographs 14. The flexible wall structure 22 may be of a variety of compositions for example but not limited to plastic, cloth, leather or canvas. However flexible walled structures are well known in the art and should not be limited to the configuration described.

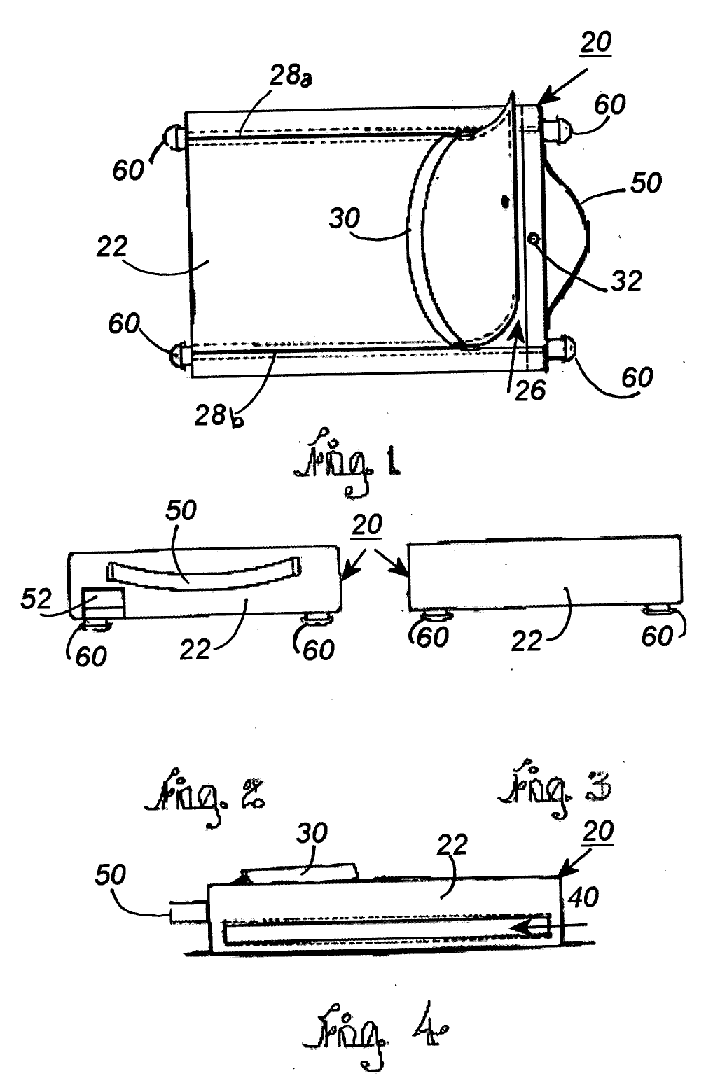

In an embodiment of the portable printing apparatus 20 depicted in FIG. 1, the apparatus 20 has a first opening 26 adapted to receive the portable printing device 12 and leading to the interior compartment 24. The first opening 26 communicates with and provides access to the interior compartment 24 such that the interior compartment 24 is accessible through the first opening 26. Although the first opening 26 could have a number of different configurations, the opening 26 is shown with a resealable opening having a resealable seam 28a. FIG. 1 also includes an optional second resealable seam 28b which communicates with the first resealable seam 28a through a common pull strap 30. The pull strap 30 allows the resealable seams 28a, 28b to operate in tandem with one another providing access to the interior compartment 24. Other possible first opening 26 configurations may include but are not limited to a single seamed opening or a multiple seamed opening working independently and therefore, the configuration of the first opening 26 should not be limited to the illustrations described. In addition, in one embodiment the flexible wall structure 22 includes a fixed securing structure 32 such as but not limited to a mechanical fastener which may include a snap, a hook and loop structure or a button for securably fastening the first opening. FIG. 1 also illustrates the apparatus 20 with an optional hand strap 50 which assists in transporting the apparatus between locations or to events. In addition to the optional hand strap 50, the apparatus 20 depicted in FIG. 1 includes a support strap fitting 60 for connecting to a support strap 62, not shown for clarification purposes in FIG. 1. The support strap 62 being securely positioned in connection with the flexible wall structure 22 of the apparatus 20 for transporting and holding the apparatus 20 in receipt of the portable printing device 12 in a generally horizontal orientation.

The hand strap 50 is visible in FIG. 2 along with an optional cable port 52 in the side of the flexible wall structure 22, the cable port 52 providing a path for a cable which may be electronically connected on one end to the portable printing device 12 positioned within the interior compartment 24 of the apparatus 20 and on the other end to a portable electronic device 16 externally located, at least part of the time, to the apparatus 20. The portable electronic device 16 communicates electronic information to the portable printing device 12, the electronic information relating in general to a digital picture. In addition, the portable electronic device may include but is not limited to a digital camera, a memory card or a portable hard drive, portable electronic devices being in general known. In addition, FIG. 3 illustrates another side of the apparatus 20 with the support strap fittings 62 positioned on the bottom of the apparatus 20.

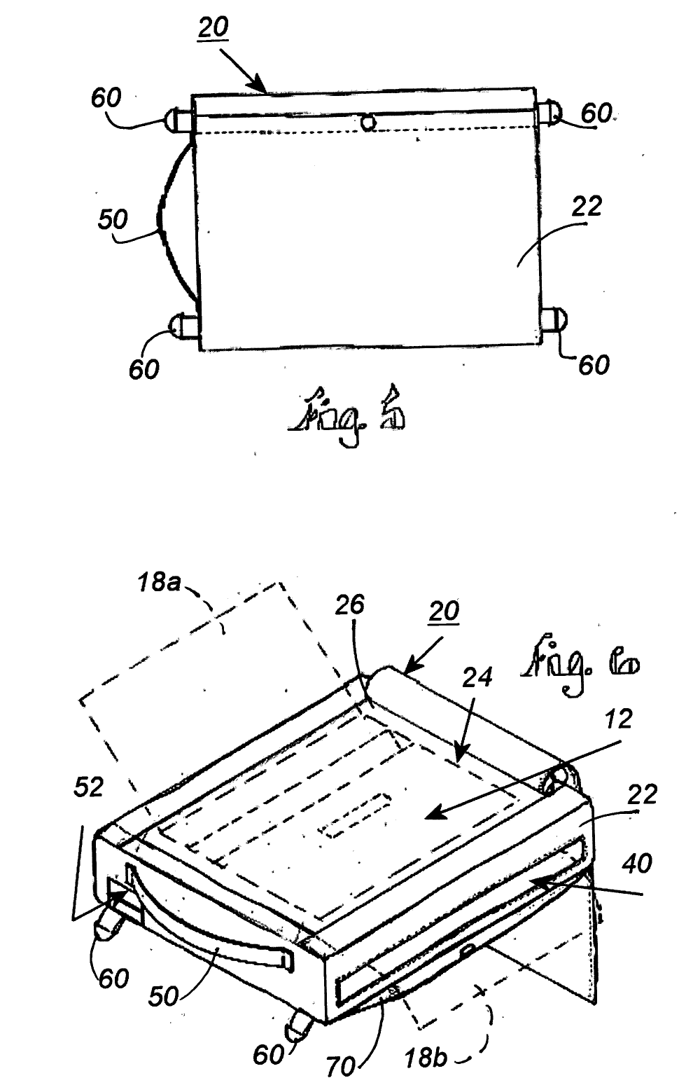

A second opening 40 is visible in FIG. 4, the second opening 40 being positioned a distance from the first opening 26 and configured to allow printed media 18b to be discharged from the portable printing device 12 through the second opening 40. The second opening 40 may include a resealable seam configured to be sealed while the second opening 40 is not in use, or the second opening 40 may be configured to remain open continuously. Resealable seams, being well known in the art, may include but are not limited to hook and loop structures, mechanical or adhesive fasteners, including zippers. The second opening 40 is optionally configured for printing photographs 14 of typical size and dimensions, the printed media 18b being discharged through the second opening 40 unobstructed.

The bottom of the apparatus 20 is visible in FIG. 5, with the hand strap 50 being secured to the flexible wall structure 22. In addition, an optional exterior compartment 70 may be associated with the bottom of the flexible wall structure 22 for storing print accessories such as but not limited to paper, print supplies or power supplies. The exterior compartment 70 includes, but is not be limited to, a configuration with a longitudinal seam extending along the exterior of the bottom panel of the apparatus 20. Support strap fittings 60 are secured to the flexible wall structure 22 and in one embodiment are associated with the corners of the apparatus 20. Alternatively, the support strap fittings 60 may be located along the flexible wall structure 22 to help hold the apparatus 20 in a generally horizontal disposition with the portable printing device 12 positioned such that photographs 14 may be printed and discharged through the second opening 40 during transport.

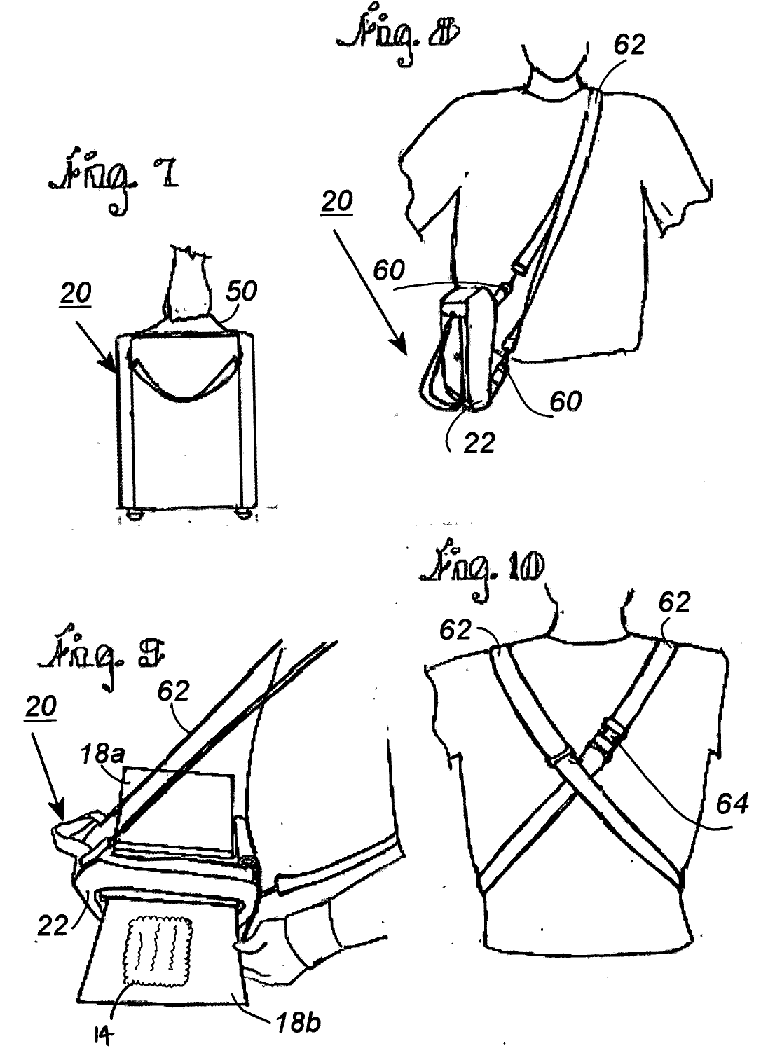

The portable printing device 12 is illustrated in FIG. 6 as being generally located within the interior compartment 24 of the portable printing apparatus 20. Print media 18a is generally received and then printed by the portable printing device 12, while printed media 18b is discharged from the portable print device 12 through the second opening 40. In one embodiment, the portable printing device 12 is positioned within the internal compartment 24 of the apparatus 20 by accessing the first opening 26 of the flexible wall structure 22. Print media 18a or printed media 18b may be located in the exterior compartment 70, located in FIG. 6, below the second opening 40. In the embodiment illustrated, the apparatus 20 in receipt of the portable printing device 12 is positioned in a generally horizontal disposition for printing photographs 14. Although other supporting structures are available in FIG. 6, the support strap fittings 60 secured to the flexible wall structure 22 in communication with the support strap 62 secure the apparatus 20 in a horizontal orientation. In the horizontal orientation, the first opening may be located in relation to the top side of the flexible wall structure 22 while the second opening may be located in relation to the sidewall side of the flexible wall structure. As may be appreciated, the apparatus 20 may alternatively be carried in a vertical configuration as illustrated in FIG. 7 with the hand strap 50 being secured to the flexible wall structure 22. Thus the user has available the apparatus 20 for transporting the portable printing device 12 which can protect the portable printing device 12 while transporting the device 12 in a vertical orientation and print photographs 14 while transporting the device 12 in a horizontal orientation.

FIGS. 8-10 show the apparatus 20 with the support strap 62 associated with and optionally connected to the support strap fittings 60 which are secured to the flexible wall structure 22 and optionally utilizing an adjustment structure 64. The support strap 62 allows the apparatus 20 to be positioned in a number of different configurations depending on the needs of the user. In addition, the ability to adjust the support strap 62 through the adjustment structure 64 allowing the user to carry the apparatus 20 in a variety of positions depending on the desired spacing between the user and the apparatus 20. In general however, the support strap positions the apparatus 20 in a generally horizontal disposition with the portable printing device 12 positioned within the apparatus 20, allowing the apparatus 20 to be transported from one event or location to another.

FIG. 8 shows the apparatus being transporting in a vertical orientation. In FIG. 9, the apparatus 20 is shown in a horizontal configuration with the support strap 62 extending outwardly from the user. The horizontal arrangement of the apparatus 20 may assist the portable printing device 12 in receiving print media 18a and discharging the printed media 18b through the second opening 40. In this arrangement, the printed media 18b receives print indicia from the portable printing device 12, the print media 18a transforming to printed media 18b as the portable printing device 12 receives and discharges the media 18a, 18b. While the portable printing device 12 is not dependant on its orientation, there are some advantages to printing in a horizontal orientation such as but not limited to the level discharge of printed media 18b from the second opening 40 or the similarity of force exerted on the portable printing device 12 while in a horizontal orientation. FIG. 10 shows an optional crossed, double strap configuration of the support strap 62, connectably secured to the flexible wall structure 22 of the apparatus, the configuration influencing the stability and support for transporting the apparatus 20 with the portable printing device 12 contained therein. In addition, FIG. 10 shows the apparatus 20 with the optional support strap adjustment structure 64, the support strap 62 becoming shorter or longer as the structure 64 is adjusted.

In connection with the current invention a method of printing photographs using the portable printing apparatus 20 in connection with the portable electronic device 16 and the portable printing device 12 in which the flexible wall structure 22 has the first and second openings 26, 40, the support strap 62 connectably securing the flexible wall structure 22 to a photographer. The portable printing device 12 is positioned within the interior compartment 24 of the flexible wall structure 22 through the first opening 26 and the flexible walled structure 22 is supported in a generally horizontal orientation with the support strap 62 secured in connection with the support strap fitting 60. The flexible wall structure 22 is then transported to an event while secured to a user by at least one support strap 62. At the event, photographic information is communicated to the portable printing device 12 from the portable electronic device 16 for printing photographs 14 onto print media 18a with the printed media 18b, containing the printed photographs 14, being discharged through the second opening 40 in the flexible wall structure 22.

Another alternative method of printing photographs 14 at an event using the portable printing apparatus 20 in connection with the portable printing device 12 which accepts print media 18a and discharges the printed media 18b after printing an image from the electronic storage device 16 may include providing the portable printing apparatus 20, transporting the apparatus 20 to an event such as but not limited to a social, recreational or professional event like a baseball game, a school dance or a honors ceremony. Once at the event, photographs 14 may be taken and stored on the portable electronic device 16 and printed using the portable printing apparatus 20 in combination with or in receipt of the portable printing device 12.

It should be understood that while certain forms of this invention have been illustrated and described, it is not limited thereto except insofar as such limitations are included in the following claims.

Having thus described the invention, what is claimed as new and desired to be secured by Letters Patent is as follows:

1. A portable printing apparatus for use with a portable printing device to print photographs and which receives unprinted media and discharges printed media, the apparatus comprising:
a flexible walled structure provided with an interior compartment suitable in size to accommodate the portable printing device therein,
said structure having a first opening therein communicating with said interior compartment and providing access to said interior compartment, said first opening being adapted to receive the portable printing device,
said structure having a second opening spaced from said first opening and adapted to permit discharge of said print media therethrough, and
a support strap secured to said wall structure for holding the apparatus in a generally horizontal disposition with the portable printing device positioned therein whereby said portable printing device may be transported from place to place and discharge said printed media through said second opening.

2. A portable printing apparatus according to claim 1 wherein said flexible walled structure includes a top side, a sidewall side and a bottom side, the top side separated from the bottom side by the sidewall side, said flexible walled structure defining a printing support surface having a horizontal configuration for printing photographs.

3. The portable printing apparatus according to claim 2 wherein the support strap is secured to the flexible wall structure in association with at least one support strap fitting.

4. The portable printing apparatus according to claim 3, wherein the support strap fitting is positioned on the bottom of the apparatus, the support strap fitting connectably securing the support strap to the flexible walled structure.

5. The portable printing apparatus according to claim 1 wherein the first and second openings further comprise resealable openings.

6. The portable printing apparatus according to claim 5 wherein the first opening further includes two seams communicating with one another for providing access to the interior compartment.

7. The portable printing apparatus according to claim 6 wherein the seams communicate with one another through a pull strap which allows the seams to operate with one another.

8. The portable printing apparatus according to claim 1 wherein the first opening further includes a fixed securing structure for securably fastening the first opening.

9. The portable printing apparatus according to claim 2 wherein the first opening is generally located in relation to the top side and the second opening is generally located in relation to the sidewall side.

10. The portable printing apparatus according to claim 1 wherein the support strap further includes two support straps connected to the exterior surface of the portable printing apparatus.

11. The portable printing apparatus according to claim 2, further including a hand strap secured to the flexible walled structure for transporting the apparatus.

12. The portable printing apparatus according to claim 1 wherein the flexible walled structure includes a cable port for providing a path for a cable connected to the portable printing device.

13. The portable printing apparatus according to claim 1 further including a portable electronic device electronically communicating with the portable printing device, the portable electronic device adapted for storing electronic information in association with a photograph.

14. A portable printing apparatus for use with a portable printing device to print photographs and which receives unprinted media and discharges printed media, the apparatus comprising:
a flexible wall structure including a top side, a sidewall side and a bottom side, the top side separated from the bottom side by the sidewall side, said flexible walled structure defining a printing support surface having a horizontal configuration for printing photographs, said flexible walled structure having an interior compartment suitable in size to accommodate the portable printing device therein;
said structure having a first opening therein communicating with said interior compartment and providing access to said interior compartment, said first opening being adapted to receive said portable printing device, said first opening further including two seams interconnected with a pull strap, said pull strap providing a communication structure between the seams providing access to said interior compartment, said first opening further having a fixed securing structure for securably fastening said first opening;
said structure having a second opening spaced from said first opening, said second opening being resealable and adapted to permit discharge of said print media therethrough, said first opening being generally located in relation to the top side and said second opening being generally located in relation to said sidewall side, and
a support strap secured to said wall structure for holding the apparatus in a generally horizontal disposition with the portable printing device positioned therein whereby said portable printing device may be transported from place to place and discharge said printed media through said second opening.

15. In combination with a portable printing device that prints photographs and which receives unprinted media and discharges printed media, a portable printing apparatus comprising:
a flexible wall structure provided with an interior compartment suitable in size to receive and accommodate said portable printing device therein,
said structure having a first opening therein communicating with said interior compartment and providing access to said portable printing device,
said structure having a second opening therein spaced from said first opening and positioned to permit discharge of said printed media therethrough, and
a support strap secured to said structure for holding the apparatus and portable printing device in a generally horizontal disposition for operation of said portable printing device and discharge of said printed media through said second opening.

16. A method for printing a photograph using a portable printing apparatus with a portable electronic device in connection with a portable printing device, the method comprising:
providing a flexible wall structure, said structure having an interior compartment, a first opening, a second opening and a support strap, said first opening of said flexible wall structure being adapted for receiving the portable printing device;
positioning the portable printing device through the first opening within the interior compartment of the flexible wall structure;
supporting the flexible wall structure in a generally horizontal orientation with at least one support strap associated with a support strap fitting connected to the flexible wall structure;
transporting said flexible wall structure while secured to the user by at least one support strap in association with the flexible wall structure in receipt of said portable printing device;
communicating photographic information to a portable printing device from a portable electronic device; and
printing a photograph onto print media, the photograph being discharged through the second opening thereof.

17. A method for printing photographs at an event using a portable printing apparatus with a portable printing device which accepts print media and discharges the printed media after printing an image from an electronic storage device, said method comprising the steps of:
providing a portable printing apparatus having a flexible walled structure with an interior compartment, a first opening separated from a second opening, the first opening providing access to the interior compartment, the first opening being adapted to receive a portable printing device;
transporting the portable printing apparatus in receipt of the portable printing device to the event, the portable printing apparatus being supported by a support strap connectably secured to the flexible walled structure of the portable printing apparatus; and
printing photographs of the event, the photographs being stored on the electronic storage device and transferred to the portable printing device, the portable printing device accepting print media and discharging printed media through the second opening of the portable printing apparatus, the printed media including the photograph.
